(19) United States
(12) Patent Application Publication
(10) Pub. No.: US 2017/0232624 A1
(43) Pub. Date: Aug. 17, 2017

(54) Shaving System

(71) Applicant: The King of Shaves Company Limited, Beaconsfield (GB)

(72) Inventor: William Ashley King, London (GB)

(21) Appl. No.: 15/042,271

(22) Filed: Feb. 12, 2016

(51) Int. Cl. B26B 21/40; B26B 21/22

(52) U.S. Cl. CPC B26B 21/4056; B26B 21/4087; B26B 21/225; G01K 7/02

(57) ABSTRACT

The invention relates to a shaving system comprising a razor with at least one razor handle with a razor head connected to it, including at least one sensor for retrieving data on the shaving behaviour of the user, and at least one power source, and including a movement sensor and a method of interpreting movement of the razor and a wireless transmitter which wirelessly transmits the sensed data to a processor. The sensor may be mounted on the handle of the razor or the razor head and includes an accelerometer to detect movement of the wet-shave razor.

The present application relates to a shaving system including a razor with a sensor for detecting various properties during shaving.

Modern wet shave razors generally employ a disposable razor cartridge. As the blades housed within the razor cartridges become dull from repeated use, the quality of subsequent shaving experiences deteriorates. Eventually, shave quality deteriorates to a point where the cartridge must be replaced. A difficulty occurs in that users often do not monitor or remember how many times a particular razor cartridge has been used. As such when it is time to change a cartridge the user may not have one on hand, thereby forcing the user to potentially endure an uncomfortable shave until such time as a replacement razor cartridge can be obtained.

Hair differs with regard to hardness, with harder hair being more difficult to cut. The hardness of hair is determined by the amount of keratin in the hair. Keratin is a natural fibrous protein that is made up of several different amino acids. The proportions of these amino acids that make up the keratin vary between people, thereby resulting in the differences in hair hardness. These differences in hair hardness in turn result in differing wear rates for a wet shave razor cartridge. Accordingly, depending on the characteristics of a user's hair, the useful life expectancy of a razor cartridge will vary from user to user. Since razor cartridges also differ (i.e. some are higher quality than others, and some have more blades that others) it is sometimes difficult for a user to determine how many shaves can be comfortably obtained from a particular type of razor cartridge. This problem is further exacerbated by the fact that different users shave differently. Some may use more strokes than others, and some may use longer or shorter strokes than others. Keratin becomes softer when exposed to moisture for a sufficiently long period. Some shave in a humid environment, after a shower which has the effect of softening the keratin, and others do not. Some shavers allow adequate time for water or shaving pre-preparation to moisten the beard before shaving and others apply the pre-preparation very quickly and shave quickly before the beard hairs have softened as much as they might otherwise have. Unsoftened keratin will lead to a less comfortable shave and also increased wear on the blades.

These factors each affect the useful life of a razor cartridge. Accordingly, there is a current need for a way by which a user can determine and monitor the useful life of a razor cartridge and also to know the optimum procedure for shaving from the point of view of shaving comfort and blade wear.

Based on the foregoing, it is a general object of the present invention to provide a shaving device that provides a user with feedback regarding the shaving behavior of the user and also the quality of a particular razor cartridge over time.

According to the present invention, a shaving system comprises a razor and a sensor and a method of retrieving data on the shaving behavior of the user. The system may include a movement sensor and a method of interpreting movement of the razor. This method requires at least one sensor, a processor, at least one memory storage device, a transmitter and at least one power source. The razor includes a razor handle with at least one razor head connected to it. The razor head may be a razor cartridge for a wet razor having at least one blade with a sharpened edge for cutting hair. The razor head may be the dry shaver type with a foil and rotating cutters beneath the foil. The sensor may be mounted directly on the handle of the razor, or on the at least one razor head or cartridge. The sensor may be detached from or detachable from the wet-shave razor. The at least one sensor may include an accelerometer to detect movement of the wet-shave razor or a thermocouple to measure temperature or a humidity sensor. The sensed data is relayed to a processor.

Various types of sensors employing different means of ascertaining, interpreting and communicating/relaying the data to a processor exist. The processor is in communication with the at least one sensor, whether in direct contact in a single unit, or whether the processor is separate from the at least one sensor. The processor utilizes at least one algorithm to interpret the inputted data from the at least one sensor. The processor identifies and selectively filters the data, removing extraneous movement and other data and stores the data against a time log. The data is transmitted to an interface device such as a smart phone, tablet laptop, pc computer or the like. Further processing is carried out on the interface device which permits visual display and interaction with the user. The information displayed is related to the data gathered, and may include the number and lengths of strokes, the duration of the shave and each stroke, the temperature and humidity and comparisons with earlier shaves or a standard or ideal shave. The at least one power source provides the required power to operate the at least one sensor and transmitter. The at least one power source may be re-chargeable. The at least one power source comprises a battery or other type of energy cell. The at least one power source may contain capacitors to store energy and resistors to limit and control current dispersion.

According to one aspect, the present invention is directed to shaving systems comprising shaving units integrated with base units. In one embodiment, the shaving system is a wet shave razor integrated with a base unit. The wet shave razor has a handle, at least one razor cartridge coupled to the handle, a control module integrated into the handle and including a sensor for detecting movement of the handle, or temperature or humidity and a transmitter for transmitting data to the base unit. The base unit, which is adapted to removably receive at least a portion of the wet shave razor, has a display for indicating data pertaining to razor cartridge use, a controller in communication with the display for sending data to the display, and transfer means for transferring data from the memory means to the controller when at least a portion of the wet shave razor is received by the base unit. The razor may include a memory for storing the data until the razor is docked in the base unit when the data is transferred to the display. Similarly the processor may be located in the base unit. The storing, displaying, and transferring of data is effected via at least one algorithm. Data displayed on the display may be the number of shaving strokes during the shave, the time duration of the shave, the temperate and humidity, and the number of shaving strokes left until the razor blade(s) should be replaced, the time, or any combination thereof.

In another aspect, the present invention is directed to methods of tracking the use of shaving devices. In one embodiment, the method comprises the steps of receiving an input signal indicative of a movement of the shaving device, maintaining a count of a number of the movements, incrementing the count in response to additional received input signals, and displaying a value in response to the counted number of movements.

One type of signal indicative of the movement of the shaving device may be a signal from a switch that operates in response to a tilting motion of the shaving device.

One advantage of the present invention is that a user can be put on notice that the razor blades of a shaving implement need to be replaced. The user is periodically reminded of the limited life of the razor blades. Accordingly, the user can change the razor blades before they degrade to the point at which nicks or abrasions occur. Thus, the end of life of the razor blade can be anticipated, and new razor blades can be purchased in advance, or the user can set up an account with his supplier to have the new razor blades automatically sent.

A sensor may also be provided to detect the onset of redness or bleeding.

The present invention and the advantages provided by it would apply equally to traditional dry shavers or hybrid wet/dry shavers since they are prone to wear information about the users use of the shaver is also valuable.

### BRIEF DESCRIPTION OF THE DRAWINGS

The foregoing and other features and advantages of the present disclosure will be more readily appreciated as the same become better understood from the following detailed description when taken in conjunction with the accompanying drawings.

FIG. 1 shows an isometric view of a multi-blade razor with a sensor located inside the razor head according to an embodiment of the present invention,

FIG. 2 is a block diagram showing the overall system organization of a razor with a sensor according to one embodiment of the present invention,

FIG. 3 shows an enlarged isometric view of a five-blade razor with sensors located inside the razor head according to another embodiment of the present disclosure,

FIG. 4 shows an enlarged view of an upper part of the razor handle and a sensor located on the upper part of the handle,

FIG. 5 shows a longitudinal cross-sectional view of the razor shown in FIG. 1 with a sensor positioned in the handle near the head of the razor,

FIG. 6 shows a cross-sectional view of the razor handle shown in FIG. 5,

FIG. 7 shows an enlarged isometric view of the handle of FIG. 5.

FIG. 8 shows an isometric view of a multi-blade razor with a modular sensor unit removably attached to the razor handle according to another embodiment of the present disclosure.

FIG. 9 shows an isometric view of a five-blade razor with a modular sensor unit located on the razor handle.

FIG. 10 shows an isometric view of the underside of FIG. 8.

FIG. 11 shows an enlarged view of the modular sensory system with the modular unit housing removed to reveal the internal electronic components.

### DETAILED DESCRIPTION

In the following description, certain specific details are set forth in order to provide a thorough understanding of various aspects of the invention. However, the invention may be practiced without these specific details. In some instances, well-known structures and methods of forming the structures associated with the razor package have not been described in detail to avoid obscuring the descriptions of the aspects of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same aspect. Furthermore, the particular features, structures, or characteristics may be combined in any suitable manner in one or more aspects of the present disclosure.

In the drawings, identical reference numbers identify similar features or elements. The size and relative positions of features in the drawings are not necessarily drawn to scale.

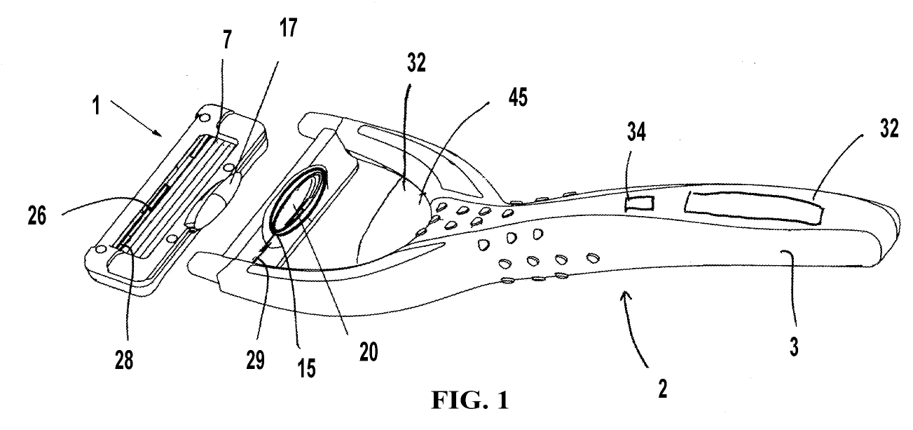

FIG. 1 shows a razor 2 according to one embodiment of the present disclosure. The razor 2 has a razor head, or cartridge 1 and five razor blades 7 positioned so that the cutting edge of the razor blades 7 are exposed to the outside of the razor head 1. The razor head 1 has a temperature sensor 26 adjacent to the razor blades 7. It may also have a strain gauge to measure the shaving force incurred during the shave.

FIG. 1 shows the temperature sensor 26 positioned behind one of the razor blades 7. Alternatively the sensor 26 may be affixed to one or more of the razor blades 7. In one alternative embodiment, the sensor 26 is affixed to a separate trimmer blade 18. Alternatively, the sensor 26 may be affixed within the razor head 1 so that the sensing surface of the sensor 26 is facing the razor blades 7 (discussed in more detail below). The sensor 26 is a temperature sensor it could also be a colour sensor that can be configured to detect various shades of redness on the user's skin. The sensor may be a biochemical sensor, an optical sensor, or other sensor that detects the presence of blood on the user's skin.

By means of these sensors both the air temperature can be measured as well as the water temperature of water from the tap as the razor is rinsed under a tap or from a bowl is measured. In addition the presence of redness of micro cuts on the user's skin is detected.

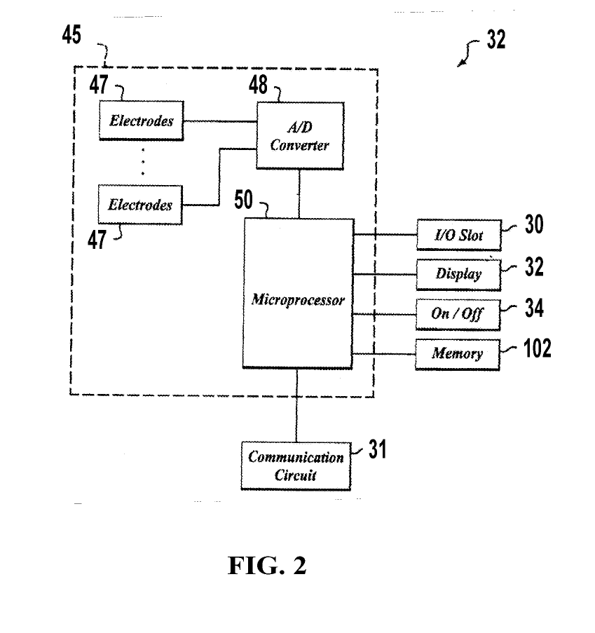

The signals generated at the sensor 26 are carried by means of electrical leads 28 through to other electrical components for processing and identification. For example, the generated signals are carried from the sensor 26 to an analog-to-digital (“AD”) converter 48 that transforms the received signals into digital data, see FIG. 2. The generated signals may also be carried to a potentiostat that controls and senses electrical changes in the sensor 26.

The digital signals output from the A/D converter are subsequently processed by a microprocessor 50 that filters the sensed data, detects significant changes that would be indicative of the user starting to use the razor based on the generated signals. The microprocessor 50 may then output the determination results to an output device, such as an Input/Output (I/O) 30, or wireless communication module 31. Most likely the display will be a smart phone or other device belonging to the user and the user will download an app to configure the smart phone to process, manage and display the data as desired by the user.

The electrical leads 28 pass through the razor head connection means 17 by means of contacts 19 which connect with contacts 15 in the corresponding parts of the handle connection means 20 so that electrically connection can be made with the new razor head when it needs to be replaced.

The sensor 26 is an integrated chip sensor having various electrical layers making up the electrical components (not shown) that process the generated signals. On a topmost layer of the chip, conductive layers form electrodes 47 for sensing temperature or colour changes. It may also include other environmental sensors which sense humidity, pressure and other environmental factors. The electrodes 47 are connected to a next layer within the sensor 26 that includes an A/D converter 48 and other sensor components such as a potentiostat. The A/D converter is on the same silicon chip integrated with the sensors. Connected to the next layer within the same chip as sensor 26 is the microprocessor 50.

The specific details of the types of temperature, humidity, colour or pressure sensors that can detect and output electrical signals are known generally in the sensor art. The electrodes 47 can be any type of sensing electrodes, such as electromechanical, electro optical, photo detectors, electrochemical or other combinations which output an electrical signal representative of a sensed parameter. Electrodes are also known that emit light at certain frequencies and then sense changes in the light after it passes through the human tissue. These electrodes can be used to detect change in the colouration of the skin to indicate too much abrasion or micro-nicking.

The results of the microprocessor 50 are conducted from the sensor 26 to the output circuits within a razor handle 3 to which the razor head 1 is electrically connected via conductive leads 28 in the razor head and conductive leads in the razor 29. The razor handle 3 may comprise any of the Input/Output (I/O) slot 30, the communication module 31, and the display 32 for receiving data from the sensor 26, all of which are examples of output circuits. The communication module 31 transmits the processed sensed data to a base unit or to a user's computer of smart phone or other device. The display may be the display on a smart device rather than a dedicated display on the razor handle. Alternatively the raw data from the sensor or sensors may be transmitted directly to a smart phone or other computer device and all of the processing carried out on the device. Alternatively the I/O slot 30 may be configured to receive electronic cards, such as a SIM card, a memory card, a connection to a computer or the like for reading from and writing to the processor 50. For example, data from the sensor 26 may be stored on a memory card inserted into the I/O slot 30 or downloads to a computer with a micro-USB type connection.

The razor handle 3 also includes an accelerometer 10 which detects movement of the razor such as would occur during shaving. The detected signals are conducted to the communication module 31. The accelerometer 10 detects the speed of movement of the razor during shaving as well as detecting each shaving stroke so the processor can resolve the number of strokes per shave. The accelerometer can also detect the orientation of the razor and thus the direction of the razor during each stroke. The overall duration taken to carry out the shave can be determined from the time when movement starts to the time when movement ends. Sensors for temperature and humidity and also a strain gauge could be included is a sensor package located in the razor handle rather than the razor head. The strain gauge can be configured to measure the resistant experienced by the razor blade edges against the beard hairs to give an indication of the softness of the hairs, which, when compared to historical data for the individual or background data on human hair, can provide an indication of the sufficient moistening of the beard before shaving and give the user and indication that the further steps need to be taken to moisten the beard before shaving should commence.

The communication module 31 is configured to wirelessly communicate the data from the sensor 26 to a separate computing device, which may be a smart phone. The display 32 is configured to show various indicators, such as the condition of the blade, the number of uses since the last cartridge was changed, the softness of the beard etc. It may also display battery power level, free space in the memory, that data has been sent to a computer, and other system functions.

In some embodiments, the display 32 may show the results of the shave analysis, such as the blood detection close to the skin, that the user is pressing the blades too harshly against the skin or that the beard hairs are insufficiently moistened.

Any or all of the sensors 10, 26 could be located in the skin engaging bar 16 which is part of the handle 3. Furthermore the sensors 10, 26 can form a modular or unitary component that can be detached from the razor handle 3 or from the razor head 1, or from the razor 2 as a whole in the case of a combined handle and razor head razor.

In other embodiments, the test results are too complicated to show on a single screen. In such cases, the razor 2 will be coupled to a computer via the communication module 31 following the collection of data by shaving. The data will be downloaded to a computer which will further analyze the data.

The razor handle 3 also has an on/off button 34, and a battery 9. The battery 9 supplies power to the sensor 26 and communication module 31 and may be a permanent battery or a replaceable battery, depending on whether the razor 2 is a one-time use or multiple use razor. The sensor 26 is coupled to the communication module 31, the display 32, the on/off button 34, and the battery 9 within the razor handle 3.

FIG. 2 shows a block diagram of a razor electronic system 60 according to the present disclosure and is generally representative of each razor as shown. The razor electronic system 60 has sensors 26, 10 that are affixed within the razor head 1 or located in the razor handle 3. As explained herein, the sensor 26 can be either on the razor blades or razor head or within the razor handle or both as shown. Accelerometer sensor 10 is best located in the razor handle but close to the razor head. According to various embodiments, the sensor electrodes 47, A/D converter 48, and a microprocessor 50 are formed on a single semiconductor chip comprising a fully integrated sensor 26. Alternatively, the electrodes 47 may be formed separately and coupled to the A/D converter, and the microprocessor 50 which are on a separate chip. In yet additional embodiments, the electrodes 47 and the ND converter 48 may be formed on a single semiconductor chip and coupled by wires to the microprocessor 50 on a separate chip. The microprocessor 50 is further coupled to various other circuits such as communication component 31, the display 32, on/off switch. A memory 102 is provided, either on the same chip as the microprocessor 50 or on a separate chip.

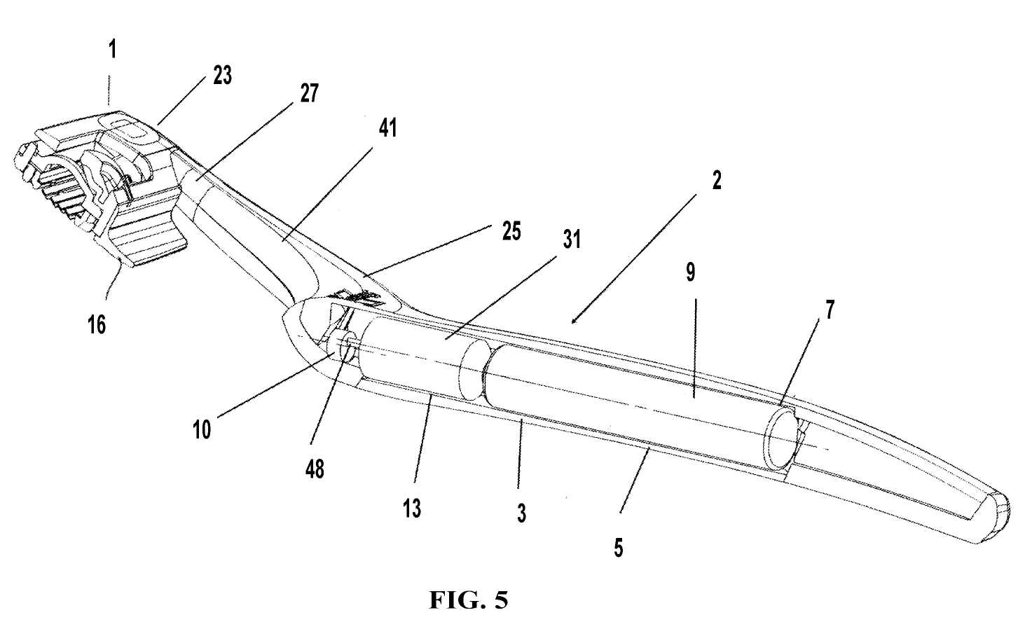

FIG. 5 shows a five-blade razor 2 according to another embodiment of the present disclosure. The razor 2 has a detachable razor head 1 that has five razor blades 7. The razor head 1 is attached to the razor handle 3, with a coupling 17, 20 as shown in FIG. 1. The handle 3 includes, an accelerometer 10 connected to the communication module 31, the display 32, the on/off button 34, and the battery 9. In this embodiment the communication module 31 includes the processor and A/D converter.

The communication module 31 transmits wirelessly to a computer device such as a smart phone and may use any suitable wireless standard, such as wi fi or lower power Blue Tooth or the like.

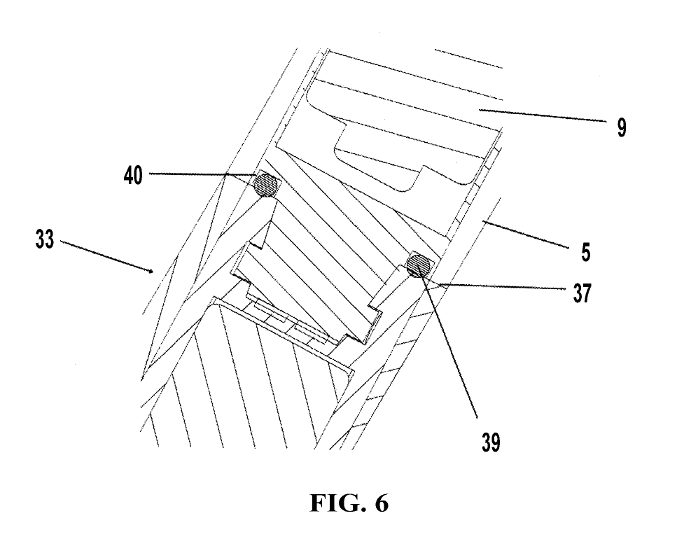

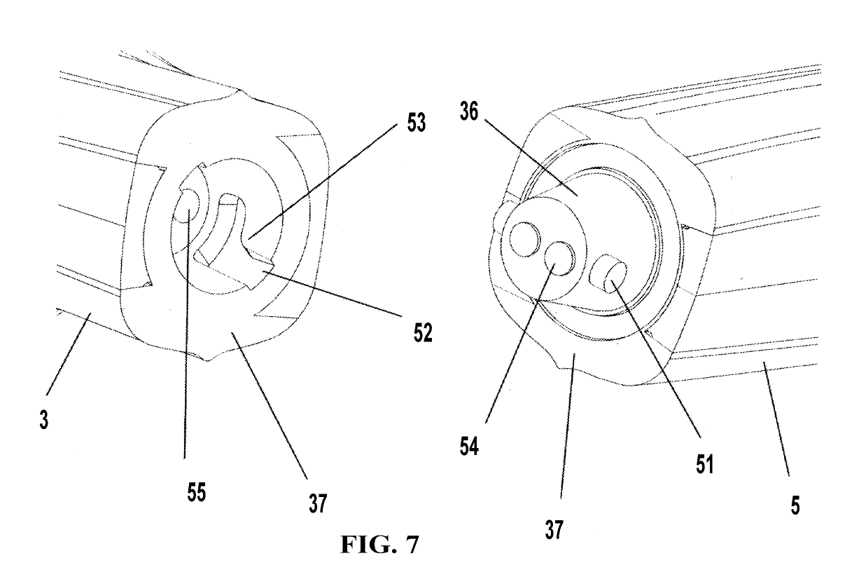

The battery 9 is preferably a re-chargeable battery which is re-charged by periodically inserting the razor in a base station (not shown) which can also be used to transfer data and verify the functionality of the components. As shown in FIG. 6, the battery may be located in a separate housing 5 of the handle 3 and removable from the remainder of the razor handle 3 at a suitable location (not shown). This removable connection 33 is shown in FIGS. 6 and 7. FIG. 6 shows the battery portion connected and at the connection surface 37 an o ring type seal 39 is provided in a circular groove 40 which ensures that the electric components inside the handle housing are isolated from the external environment. FIG. 7 shows the parts separated in which the battery housing 5 is connectable to the remaining housing 3 by means of a bayonet fitting 51, 52. The housing 5 encloses the battery 9 inside the razor handle 3 and may be removed to replace the battery 9. The remaining housing 3 and battery housing 5 have mutually co-operating tapered connecting surfaces 36, 53 together with the seal means 39, 40 which ensures that the electric components inside the handle housing are isolated from the external environment. When connected the electrical connections 54, 55 are in contact which connects the power from the battery electrically to the transmitter 31 and sensors 10, 26.

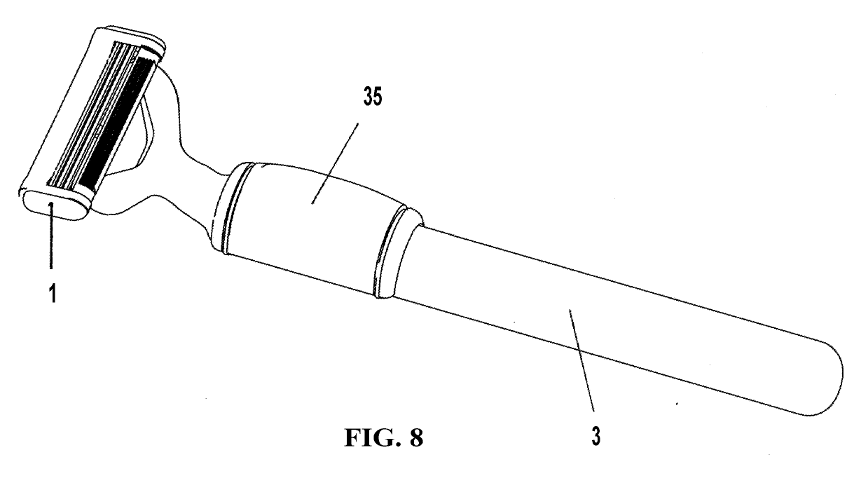

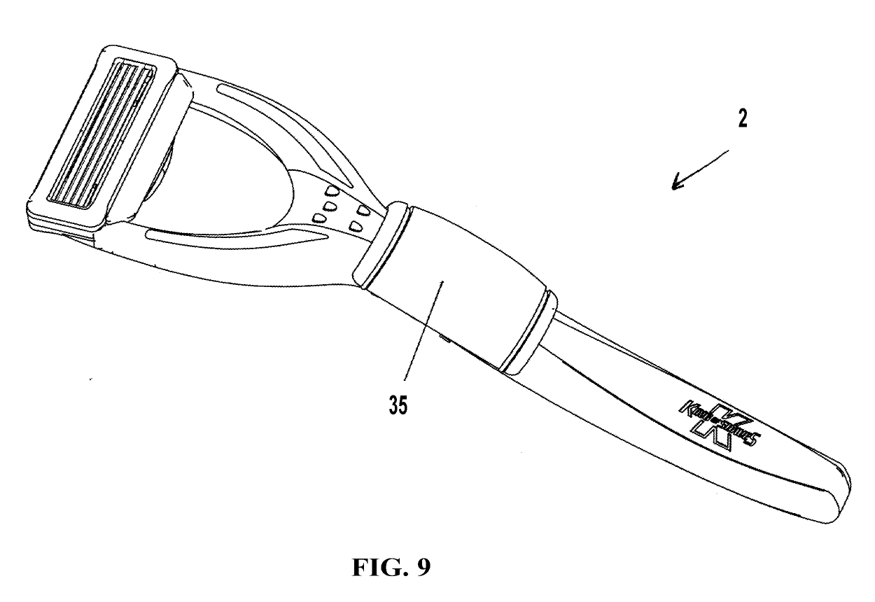

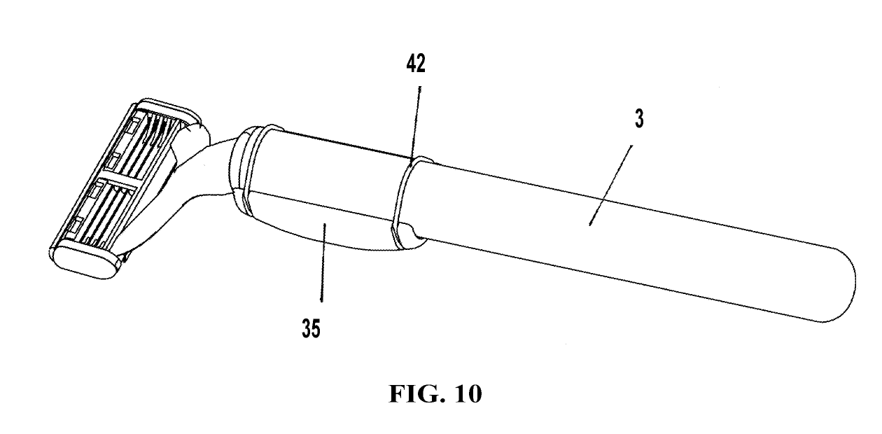

In an alternative embodiment, shown in FIGS. 8 to 11, the battery forms part of an integrated modular sensory system 35 together with the sensor and the transmitter, with the battery being a smaller button type battery The module 35 is self-contained and self-powered and is removable, via a modular system attaching means 42, from the razor 2. The attaching means 42 comprises a pair of elastic cords which are located in grooves in the housing 38 of the module 35 and are dimensioned to fit around the razor handle 3 to fixedly attach the module to the razor handle 3 rigidly enough that the module 35 remains affixed during normal use of the razor. Elastic cords of alternative dimensions can be provided to enable the module 35 to be attached to alternative razor handles of differing dimensions from alternative razor manufacturers. In this embodiment the battery is non-rechargeable and is self contained within the integrated sensor electronic components 60. It will be appreciated that alternative attachment means could be provided, for example plastic detents could be integrally moulded with the module housing 38 to permit the module to be clipped onto the razor handle 3, although this would limit the range of razor handles that the module 35 could be effectively attached to.

Providing the sensor in a removable module provides a number of benefits. It allows the module 35 to be sold separately from the razor handle 3, it allows it to be sent for repair or for data downloading separately from the razor handle and it also allows the module to be used for other purposes such as for example data collection during other activities than shaving, such as sports.

In an alternative embodiment of a detachable sensor module, the battery may be re-chargeable and may be re-charged automatically when is attached to the razor 2, by suitable electrical connection means which are in contact when the module is attached to the razor, and the sensor battery is re-charged by a further razor battery in the razor handle housing, or the sensor battery may be re-charged by a docking station.

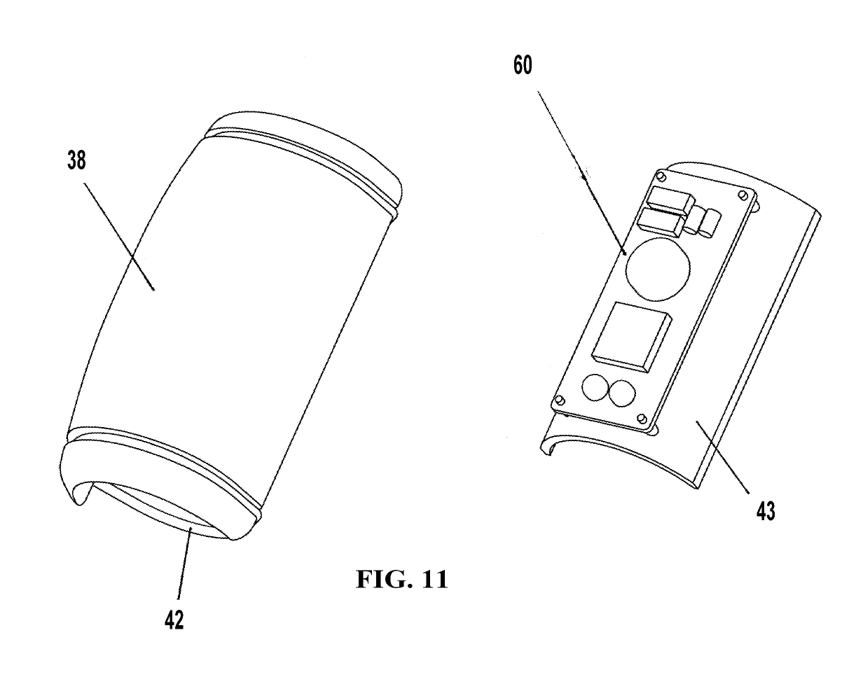

In the embodiment shown in FIGS. 8 to 11, the integrated electronic components 60 are protected from water damage by being enclosed in a modular housing cover 38, shown in FIG. 11, which connects to the modular housing base 43.

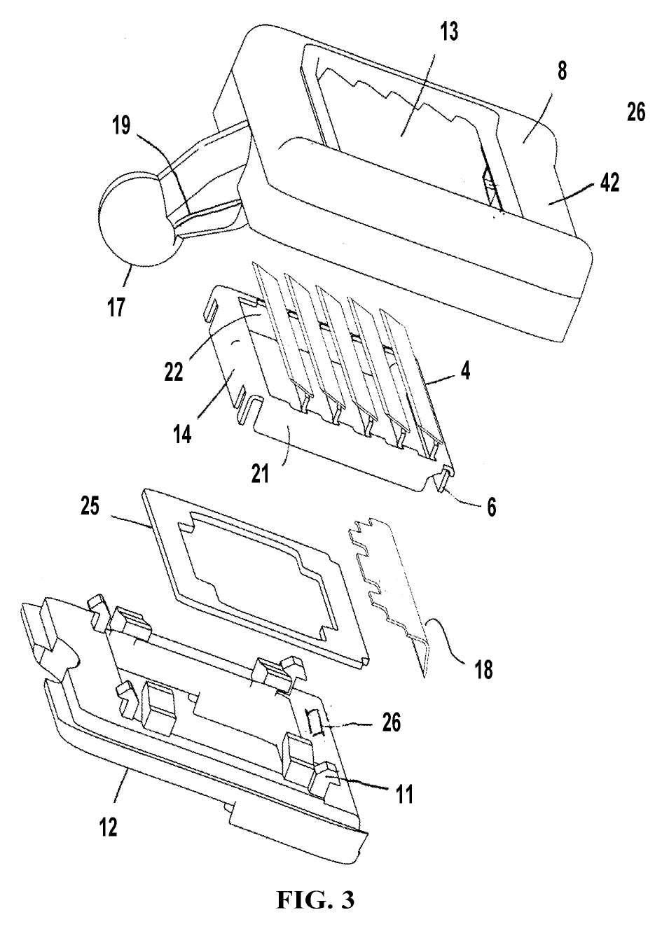

According to the embodiment shown in FIG. 2, the razor head 1 has the electrodes 47 for the sensor 26 positioned on a middle one of the razor blades 4 so that at least a portion of the sensing surface of the sensor 26 is exposed to the ambient environment outside the razor 2. Known techniques may be used to affix the electrodes 47 to the razor blades 4. Alternatively, the electrodes 47 may be positioned on any one of the razor blades 4 including behind the razor blades 4 as shown in FIG. 3.

In addition, in the embodiments, the microprocessor 50 is in the handle 3 of the razor 20. In some systems, the microprocessor 50 will be expensive and it will be desired to reuse the microprocessor many times and so the processing can be carried out in the attendant device such as a smart phone and only the sensor or sensors and transmitter are located in the razor and the data is transmitted immediately or streamed to the smart phone. In one embodiment, the microprocessor 50 is on a separate chip from the A/D converter 48 and the electrodes 47. The combination of these components makes up the entire sensor 26.

In this case, only the head 1 of the razor is removed at joint 17, 20 and discarded when the blades are worn and a new head 1 is attached. The components in the handle, such as communication module 31, display 32, battery, etc., are reused.

The electrodes 26 in the razor head are coupled to the processor and transmitter 31 through wires 28 affixed to the razor head 1 to which the electrodes 26 are attached.

As another example, the razor 2 of FIG. 1 may have only the transmitting module 31 but not the display 32 or the processor 50. Alternatively a memory card or computer connection cord may be inserted into an I/O slot 30 to store the alphanumerical values or data output by the microprocessor in the sensor 26. After the data is stored, the memory card may be removed and inserted into a separate computing device to download and associate the data with the patient's medical record, or simply to read the results of the data. In yet another alternative embodiment, any part of the razor 2 may only have the communication component 31 that wirelessly communicates the data from the sensors 26 to the separate computing device. Thus, various combinations of electronics can be placed in the razor 2.

In the embodiment shown in FIG. 3, the sensor 26 is a two part sensor positioned flat the lower part 12 and correspondingly the upper part 8 of the razor head 1 near a trimmer blade 18 and is affixed using any known technique of attaching a semiconductor chip to a PCB, plastic or rubber surface. Since affixing dies to PCBs, plastics or other insulator is well known in the art, the details for affixing the sensor 26 at the end of razor blade head 1 need not be described in further detail.

The razor head 1 is formed from an upper part 8 and a lower part 12, each with an opening 13 through which the blade edges 4 are exposed to the skin. The blades 4 are provided on a blade rack 14 which has side portions 21, 22 and a rear portion 6. The sensor 26 is shown located on the underside of the upper portion 8 at the rear side of following side of the razor head compared to the direction of shaving. There is further provided a rear trimming blade 18 attach to the rear portion 6 and a sacrificial aluminium anode 25, all of which blade rack 14, anode 25, and trimmer blade 18 are all sandwiched between the upper 8 and lower parts 12 which are fixedly connected together by attaching means 11. The sensor 26 could be readily located at any suitable location on the blade rack 14, the blades, the upper part 8, the lower part 12 or the anode 25.

The sensor 26 is coupled to the electrical components shown in the handle housing 5 of the razor handle 3 via insulated wires 28, 29, which are affixed to the razor parts using any known technique of securely attaching wires to a plastic surface which provides the isolation, or where necessary isolated wires and attached to the metal surface of the blade. The isolated wires 28, 29 are isolated to prevent stray currents, short circuiting if wet, and introduction of noise into the system. The isolated wires 28, 29 are coupled to the electrical components of the razor handle 3 via electrical contacts 19 on the razor head connecting means 17, 20.

The isolated wires 28, 29 provide the power source, ground, and data lines to and from the sensor 26. In an alternative embodiment, the isolated wires 28, 29 provide the power source and the data lines, but the razor blades 4, 18 to which the sensor 26 is attached provides a ground for the sensor 26. A metal grounding pad (not shown) formed on the underside of the sensor 26 makes contact with the razor blade and is used to ground the sensor 26 to the razor blade.

Positioning the sensor 26 nearer the cutting edges of the razor blades 4 allows the sensor to come into close contact with the skin and is more easily rinsed clean.

In one embodiment, the razor blades 7 may be equally projecting and spaced apart in the vertical direction from one another. Alternatively, one or more of the razor blades 7 may be projecting more than the other razor blades. Additionally, the vertical spacing between the razor blades 7 may be different in between each razor blade. For example, the topmost razor blade may be positioned closer to the middle razor blade than the middle razor blade is to the bottommost razor blade.

In one aspect, varying the spacing and positioning of the razor blades may depend on the placement of the sensor 26. For example, if the sensor 26 is positioned on the underside of the middle razor blade, then the shaving edge of the adjacent razor blade may be positioned further back. Additionally, the spacing between the middle razor blade and the bottommost razor blade may be greater than the spacing between the topmost razor blade and the middle razor blade. Positioning the razor blades 4 in this way may increase the area of skin the sensor 26 is exposed to.

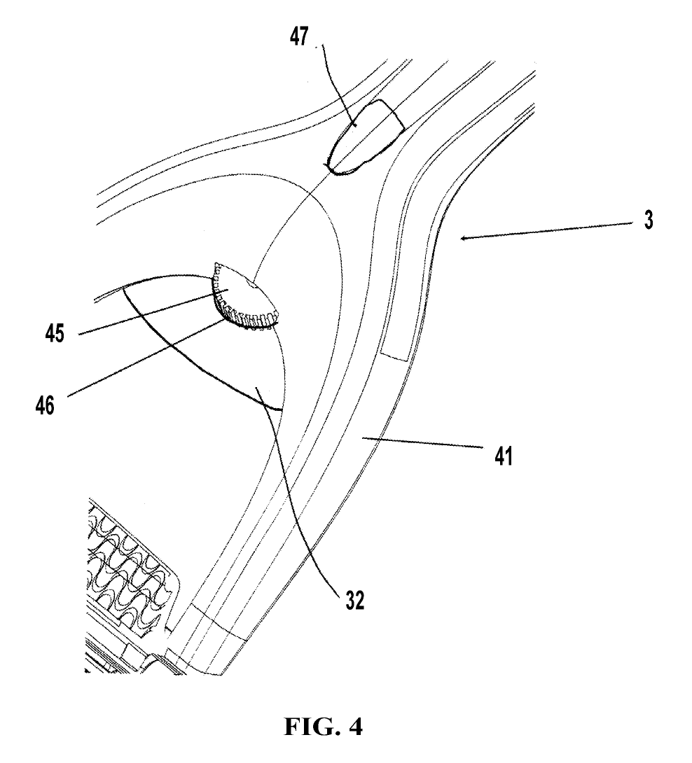

To the user, the razor will be used normally and there will be no perceived difference in the shave compared to normal use. FIG. 4 shows an enlarged view of the upper part of the razor handle. The accelerometer sensor 10 is shown located centrally in the razor handle between a pair of fork arms 41 but within the body of the razor handle 3. Also shown extending between the forks arms 41 is the display 32 which extends between the fork arms 41 and provides a generous area for the user to view selected information outputted from the sensors 26, 47 about the status of the blades or the users skin or beard, progress of the shave. The user can make a selection of the information to be displayed by means of the display control button 45, which includes a finger engaging portion 46 including a grip surface which facilities gripping by a digit of the user even when wetted.

As well as an accelerometer 10, other motion sending technology could be used such as a simple gravity switch which detects the changes in orientation of the handle. A number of such switches could be provided with different base orientations to provide more accurate data on the motion of the razor.

The data that could be displayed on the razor handle display 32 will be relatively simple data such as the number of shaving strokes used, the shaving orientation of the razor, the time spent shaving or the velocity of the shaving strokes. Any graphical or numerical information in a format which may aid the user in the improvement of their shaving technique.

More sophisticated data will be transmitted to the computer device. Furthermore the user's computer device will be connected to the internet to the manufacturer or a service provider so that based on analysis of data set and usage against average user data or other, data may be transferred to the manufacturer or service provider or other third party to automatically reorder replacement cartridges. The usage habits and reorder scheduling can be dynamically tailored to each individual user, obviating the need for manual order or purchase of replacement cartridges. For example a particular user may have a preference for a particular type of razor or blade set up and this bespoke razor head can be provided economically with this advanced knowledge.

Based on usage data set, data may be used to reward user with loyalty points, discounts or money off rewards, rewarding regular users with genuine savings or provision of other products to generally improve their shaving or purchase experience.

The data set may also be geo-tagged use location data on the computer device and used by third party to be analyse and use, for research and logistical purposes, the geographical usage of the product.

The data from the razor will interface exclusively with a dedicated app provided by the manufacturer or service provider which will be downloaded over the internet to the computer device. The computer device as well as being a smart phone or tablet could also be a smart watch or other wearable device.

Because the razor blades 4 are staggered and the head swivels, the sensor 26 is positioned at an angle that is parallel to the shaving plane of the razor head 1 and will preferably contact the skin during use.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

### COMPONENT LIST

1. Razor Head
2. Razor
3. Razor Handle
4. Razor Blades
5. Battery Housing
6. Rear portion
7. Razor Blades
8. Upper part
9. Battery
10. Accelerometer
11. Attaching Means
12. Razor head lower part
13. Opening
14. Blade rack
15. Contacts
16. Skin engaging bar
17. Razor head connecting means (also coupling, also joint)
18. Trimmer Blade
19. Electrical contacts
20. Handle Connection Means (also coupling, also joint), also razor
21. Side portion
22. Side portion
23. (not used)
24. (not used)
25. Aluminium anode
26. The sensor (also temperature sensor), also electrodes
27. (Not Used)
28. Isolated Wires (also conductive leads, wires, insulated wires, electrical leads)
29. Conductive Leads in the Razor (look like in Handle in FIG. 1) (also isolated wires)
30. Input/Output Slot
31. Wireless Communication Module (also Communication Component), also transmitter (also transmitting module)
32. Display,
33. Removable connection
34. On/Off button
35. Modular Sensor
36. Connecting surface
37. Connection surface
38. Modular Housing Cover
39. O ring seal (also seal means)
40. Circular groove (also seal means)
41. Fork arms
42. Modular Attaching Means
43. Modular Housing Base
44. (Not Used)
45. Display button
46. Finger engaging portion of the display button
47. Electrodes
48. Analogue to Digital Converter
49. (Not Used)
50. Microprocessor, (also Processor)
51. Bayonet Fitting
52. Bayonet Fitting (Corresponding to 51)
53. Connecting Surface (Corresponding to 36)
54. Electrical connection
55. Electrical Connection
56. (Not Used)
60. Electronic Components
102. Memory

1. A shaving system comprising a razor with at least one razor handle with a razor head connected to it, the razor head having a cutting head for cutting hair, the shaving system including at least one sensor for retrieving data on the shaving behaviour of the user, and at least one power source, characterised in that the at least one sensor includes a movement sensor and a method of interpreting movement of the razor and in that the shaving system includes a wireless transmitter which wirelessly transmits the sensed data to a processor.

2. A shaving system according to claim 1, characterised in that the sensor is mounted on the handle of the razor.

3. A shaving system according to claim 1, characterised in that the sensor is mounted on the razor head.

4. A shaving system according to claim 1, characterised in that the at least one sensor includes an accelerometer to detect movement of the wet-shave razor.

5. A shaving system according to claim 1, characterised in that the at least one sensor includes a strain gauge.

6. A shaving system according to claim 1, characterised in that the at least one sensor includes a thermocouple to measure temperature.

7. A shaving system according to claim 1, characterised in that the at least one sensor includes a humidity sensor.

8. A shaving system according to claim 1, characterised in that the at least one sensor is in communication with a processor which utilizes at least one algorithm to interpret the inputted data from the at least one sensor.

9. A shaving system according to claim 1, characterised in that the at least one sensor produces data that is transmitted to an interface device such as a smart phone, tablet laptop, pc computer or the like, to permit visual display.

10. A shaving system according to claim 8, characterised in that a skin engaging guard surface is provided which is integral with the razor handle and on which is located at least one sensor.

11. A shaving system according to claim 1, characterised in that the at least one sensor measures the number shaving strokes.

12. A shaving system according to claim 1, characterised in that the at least one sensor measures the duration of the shave.

13. A shaving system according to claim 1, characterised in that the at least one power source provides the required power to operate the at least one sensor and transmitter.

14. A shaving system according to claim 13, characterised in that at least one sensor a power source and the transmitter are provided in a separate module which is removable from the razor.

15. A shaving system according to claim 1, characterised in that the at least one sensor includes a base unit in which the razor docks to re-charge the power source and/or to transmit data.

16. A shaving system including a razor with a handle, at least one razor head coupled to the handle, a control module integrated into the handle and including a sensor for detecting movement of the handle, or temperature or humidity and a transmitter for transmitting data to a base unit, the base unit being adapted to removably receive at least a portion of the razor, and including a display for indicating data pertaining to razor head use, a controller in communication with the display for sending data to the display, and transfer means for transferring data from the memory means to the controller when at least a portion of the razor is received by the base unit.

17. A shaving system according to claim 16, characterised in that there is a processor located in the base unit.

18. A shaving system according to claim 16, characterised in that the razor is a wet shave razor with at least one blade having a cutting edge.

19. A shaving system according to claim 16, characterised in that the razor is a dry shave razor with at least one foil.

20. A shaving sensor system for attachment to at least one razor or razor handle, the shaving sensor system including at least one sensor for retrieving data on the shaving behaviour of the user, and at least one power source, characterised in that the at least one sensor includes a movement sensor and a method of interpreting movement of the razor, to determine at least the start and the end of a shaving process, and in that the shaving sensor system includes a wireless transmitter which wirelessly transmits the sensed data to a processor.
